(19) United States
(12) Patent Application Publication
(10) Pub. No.: US 2016/0069837 A1
(43) Pub. Date: Mar. 10, 2016

(54) OBJECT INFORMATION ACQUIRING APPARATUS

(71) Applicant: CANON KABUSHIKI KAISHA, Tokyo (JP)

(72) Inventors: Takaaki Nakabayashi, Kawasaki-shi (JP); Robert A. Kruger, Oriental, NC (US)

(21) Appl. No.: 14/838,978

(22) Filed: Aug. 28, 2015

Related U.S. Application Data
(60) Provisional application No. 62/046,330, filed on Sep. 5, 2014.

(51) Int. Cl. G01N 29/024

(52) U.S. Cl. CPC G01N 29/024; G01N 2291/011

(57) ABSTRACT

An object information acquiring apparatus includes: a matching solution that is prepared by adding, to a solvent, a solute having a higher hydrophilicity than the solvent, and propagates an acoustic wave generated from an object; a plurality of acoustic wave detection elements that receives the acoustic wave via the matching solution; a support that supports the plurality of acoustic wave detection elements so that directional axes of at least a part of the acoustic wave detection elements converge, and holds the matching solution; a position control unit that changes the positional relationship between the object and the support; and an acquisition unit that acquires characteristic information on the object based on the reception result for each positional relationship of the plurality of acoustic wave detection elements.

### BACKGROUND OF THE INVENTION

1. Field of the Invention

The present invention relates to an object information acquiring apparatus.

2. Description of the Related Art

For an object information acquiring apparatus, a photoacoustic apparatus, which irradiates light onto an object (e.g. breast), receives an acoustic wave generated from the object and acquires characteristic information of the object, has been proposed. This apparatus includes a cup type holder that holds the object, and a probe unit that has a hemispherical-shaped housing in which a plurality of acoustic wave detection elements for receiving the acoustic wave from the object is disposed. Further, an optical system for guiding the light from the light source to the object is disposed in the lower part of the hemispherical-shaped housing. In order to irradiate the light onto the object and receive the acoustic wave that propagates through the object, a matching solution to acoustically couple the holder and the plurality of acoustic wave detection elements held by the holder is filled into the space between the holder and the probe unit. The matching solution is supplied from a tank to the space between the holder and the probe unit by a pump via a pipe connected to the lower part of the probe unit (Robert A. Kruger, Richard B. Lam, Daniel R. Reinecke, Stephen P. Del Rio, and Ryan P. Doyle “Photoacoustic angiography of the breast”, Medical Physics, Vol. 37, No. 11, November 2010).

An acoustic apparatus, which acquires information on an object by transmitting an acoustic wave to the object and receiving the reflected acoustic wave using acoustic wave detection elements that can transmit/receive the acoustic wave, is also known.

### SUMMARY OF THE INVENTION

However, when the matching solution is supplied to the hemispherical-shaped housing, in some cases bubbles may be generated on an inner surface of the housing or in the holder. If these bubbles adhere to the holder or the acoustic wave detection elements held by the holder, or if they float in the matching solution, the acoustic wave from the object may be reflected by the bubbles. In this case, the acoustic wave detection elements cannot receive the acoustic wave signal, which drops the image quality, or the acoustic wave signals reflected by the bubbles appear as noise.

With the foregoing in view, it is an object of the present invention to provide an object information acquiring apparatus that can suppress the generation of bubbles when the matching solution is supplied.

To solve the above problem, the present invention uses the following configuration. In other words, the present invention is an object information acquiring apparatus comprising: a matching solution that is prepared by adding, to a solvent, a solute having a higher hydrophilicity than the solvent, and propagates an acoustic wave generated from an object; a plurality of acoustic wave detection elements that receives the acoustic wave via the matching solution; a support that supports the plurality of acoustic wave detection elements so that directional axes of at least a part of the acoustic wave detection elements converge, and holds the matching solution; a position control unit that changes a positional relationship between the object and the support; and an acquisition unit that acquires characteristic information on the object based on a reception result for each positional relationship of the plurality of acoustic wave detection elements.

The present invention also uses the following configuration. In other words, the present invention is an object information acquiring apparatus comprising: a matching solution that is prepared by adding a solute having hydrophilicity to water, and propagates an acoustic wave generated from an object; a plurality of acoustic wave detection elements that receives the acoustic wave via the matching solution; a support that supports the plurality of acoustic wave detection elements so that directional axes of at least a part of the acoustic wave detection elements converge, and holds the matching solution; a position control unit that changes a positional relationship between the object and the support; and an acquisition unit that acquires characteristic information on the object based on a reception result for each positional relationship of the plurality of acoustic wave detection elements.

According to the present invention, an object information acquiring apparatus, which can suppress the generation of bubbles when the matching solution is supplied, can be provided.

Further features of the present invention will become apparent from the following description of exemplary embodiments with reference to the attached drawings.

### BRIEF DESCRIPTION OF THE DRAWINGS

FIG. 1A and FIG. 1B are schematic diagrams depicting Example 1 of the object information acquiring apparatus of the present invention (Example 1);

FIG. 2A and FIG. 2B are schematic diagrams depicting an acoustic wave detection unit according to Example 1;

FIG. 3A and FIG. 3B are end views of the acoustic wave detection unit according to Example 1; and

FIG. 4A and FIG. 4B are schematic diagrams depicting a case of supplying a matching solution to the acoustic wave detection unit of Example 1.

### DESCRIPTION OF THE EMBODIMENTS

Embodiments of the present invention will be described with reference to the drawings. As a rule, a same composing element is denoted with a same reference numeral, for which redundant description is omitted. The following detailed calculation formula, calculation procedure and the like should be properly changed in accordance with the configuration and various conditions of the apparatus to which the present invention is applied, and are not intended to limit the scope of the invention.

The object information acquiring apparatus of the present invention includes an apparatus that utilizes ultrasonic echo technology, transmits an ultrasonic wave to an object, receives the reflected way (echo wave) reflected inside the object, and acquires object information as image data, which is characteristic information on the object. The object information acquiring apparatus also includes an apparatus utilizing a photoacoustic effect that irradiates light or an electromagnetic wave onto an object, receives an acoustic wave which is generated inside the object and propagates, and acquires the object information as image data.

In the case of the former apparatus that utilizes ultrasonic echo technology, the object information to be acquired is information reflecting the difference of acoustic impedance of the tissue inside the object. In the case of the latter apparatus that utilizes the photoacoustic effect, the object information to be acquired is: generation source distribution of the acoustic wave that propagates by the irradiation of the light; initial sound pressure distribution inside the object; absorption density distribution or absorption coefficient distribution of light energy derived from the initial sound pressure distribution; and concentration distribution of a substance constituting the tissue. Examples of the concentration distribution of a substance are oxygen saturation degree distribution and oxy/deoxyhemoglobin concentration distribution.

The acoustic wave referred to in the present invention is typically an ultrasonic wave, and includes a generated-wave called a “sound wave” and an “acoustic wave”. An acoustic wave that is generated by the photoacoustic effect and propagates is called a “photoacoustic wave” or an “optical ultrasonic wave”. An acoustic wave detection element receives an acoustic wave generated or reflected inside the object.

Here an axis that extends from an acoustic wave detection element (start point) along a direction to the highest reception sensitivity of the acoustic wave detection element is called a “directional axis”.

Further, a characteristic where the reception sensitivity of an acoustic wave detection element depends on the orientation of the acoustic wave detection element is called “directivity”.

### Example 1

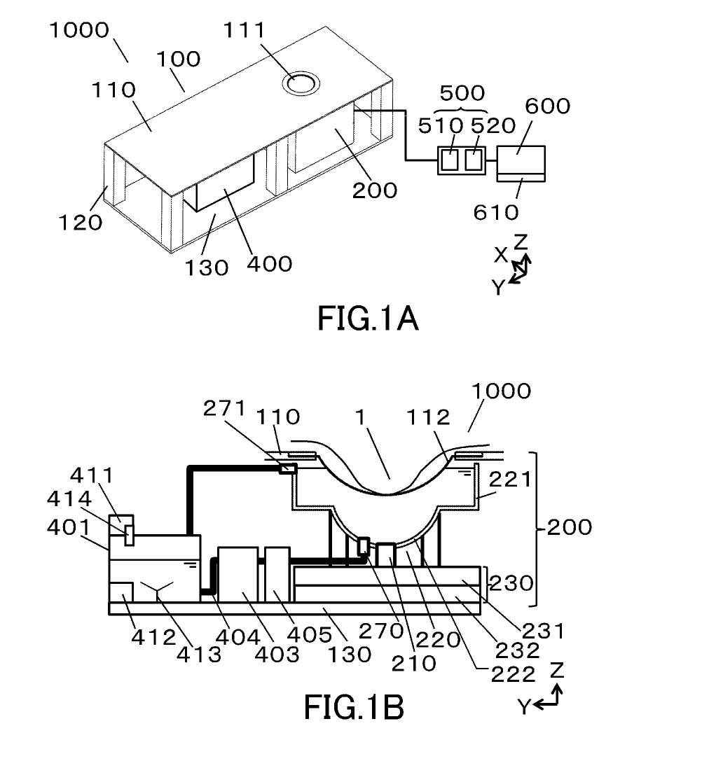

FIG. 1A and FIG. 1B are schematic diagrams depicting Example 1 of an object information acquiring apparatus according to an embodiment of the present invention. FIG. 1A is a perspective view depicting the object information acquiring apparatus 1000 of this example (hereafter called “apparatus”). FIG. 1B is a cross-sectional view of the apparatus 1000 of this example. The apparatus 1000 of this example is basically constituted by a bed unit 100, a measurement unit 200, a matching solution circulation unit 400, a computer 500 and a monitor 600.

### Bed Unit 100

The bed unit 100 is a unit on which a subject lies face down (prone position). The bed unit 100 is constituted by a bed 110 which is a support member for maintaining the position of the subject, bed posts 120 that support the bed, and a base 130. The bed 110 has an opening 111 to insert an object 1, such as a breast. The opening 111 has a cup 112 which holds the inserted object 1. It is preferable that material of the cup 112 has an acoustic impedance similar to that of the object 1 (1.5 to 1.6×10⁶ kg/m²sec), and has a high light transmittance (preferably 90% or more) in the case of an apparatus that utilizes the photoacoustic effect. In concrete terms, polymethylpentene, PET, polycarbonate, elastomer or the like can be used. The thickness of the cup 112 should be thin, so as to minimize attenuation of the ultrasonic wave. For measurement, it is preferable to fill the matching solution (e.g. gel, water) into the cup 112 so as to implement acoustic matching of the object 1 and the cup 112, that is to acoustically couple the object 1 and the cup 112. The holding member to hold the object 1 may be a sheet type film or a rubber sheet, instead of a cup. Further, the present invention is not limited thereto, and the object 1 may be inserted through the opening 111, and the photoacoustic measurement may be directly performed without using such a holding member as the cup 112.

### Measurement Unit 200

The measurement unit 200 is an acoustic wave detection unit that detects an acoustic wave that propagates through the object 1, irradiates light onto the object 1, and receives the generated-ultrasonic wave from the object 1 using an acoustic wave detection unit 220. The acoustic wave detection unit 220 is formed from a plurality of acoustic wave detection elements 223 held approximately hemispherically by a support 222. The measurement unit 200 is constituted by a light irradiation unit 210 that irradiates light onto the object 1, an acoustic wave detection unit 220 that has an approximate hemispherical shape and receives an ultrasonic wave from the object 1, and a scanning stage 230 that two-dimensionally scans the light irradiation unit 210 and the acoustic wave detection unit 220.

### Matching Solution Circulation Unit 400

The matching solution circulation unit 400 is a unit that supplies and discharges matching solution to/from the acoustic wave detection unit 220 and the tray 221. For the matching solution, it is preferable to use a solution prepared by adding a surfactant adding a surfactant (solute) to oil or the like (solvent), or water having a high transmission characteristic and a low attenuation characteristic, and stirring the solution. The surfactant has a higher hydrophilicity than the solvent (or has hydrophilicity if water is used). The matching solution circulation unit 400 is constituted by a tank 401, a pump 403, a tube 404 and a flow meter 405. The tank 401 is for storing the matching solution. The pump 403 is for supplying the matching solution to the acoustic wave detection unit 220 and the tray 221, and the flow rate of the matching solution can be detected by the flow meter 405. The flow meter 405 is disposed in a later mentioned supply path. The flow rate of the matching solution may be displayed directly on a display unit (not illustrated) of the flow meter 405 so that the user can see, or may be displayed on a later mentioned monitor 600. The tube 404 is connected with the tank 401, the pump 403, the supply joint 270 and the discharge joint 271. Because of the pump 403, circulation of the matching solution between the acoustic wave detection unit 220 and the tank 401 becomes possible. In other words, the circulation path of the matching solution is formed of the supply path from the tank 401 to the supply joint 270, and the discharge path from the discharge joint 271 to the tank 401. To adjust the flow rate, the user may control the drive amount of the pump by inputting data via a later mentioned input unit 610 while checking the flow rate. An operator may input a flow rate value, then the flow rate measurement value from the flow meter 405 is fed back, and is compared with the input flow rate value, whereby the negative feedback control is performed so that the flow rate of the matching solution becomes the input predetermined flow rate value, and the flow rate is automatically adjusted. This negative feedback control is performed by a negative feedback control unit. The negative feedback control unit is disposed in an operation unit 510 or may be disposed separately from the operation unit 510, or may be constituted by logic-based hardware or may be constructed by software. By controlling the flow rate of the matching solution to be a predetermined flow rate, bubbles in the acoustic wave detection unit 220, generated by the force of supplying the matching solution to the acoustic wave detection unit 220 can be minimized.

### Computer 500

The computer 500 (corresponding to the acquisition unit) has an operation unit 510 and a storage unit 520. The operation unit 510 is typically constituted by such elements as a CPU, a GPU and an A/D convertor, and by such circuits as FPGA and ASIC. The operation unit 510 may be constituted by one element or one circuit, or may be constituted by a plurality of elements and circuits. An element or a circuit may execute each processing performed by the computer 500. The storage unit 520 is typically constituted by such storage media as a ROM, a RAM and a hard disk. The storage unit 520 may be constituted by one storage medium or may be constituted by a plurality of storage media. The operation unit 510 performs signal processing on an electric signal output from a plurality of acoustic wave detection elements 223 (corresponding to the reception result), which is described later. In other words, A/D conversion and amplification are performed on an electric signal, and the result is transmitted to a subsequent step. The operation unit 510 also plays a role of a control unit to control operation of each composing element of the apparatus 1000. It is preferable that the computer 500 is constructed such that a plurality of signals can be simultaneously processed (pipeline processing). Thereby the processing time to acquire the object information can be shortened. The processing performed by the computer 500 may be stored in the storage unit 520 in advance as a program that the operation unit 510 executes. The storage unit 520 in which a program is stored is a non-temporal recording media.

### Monitor 600

The monitor 600 is an apparatus that displays the object information output from the computer 500 as a distribution image, numeric data on a specific region of interest or the like. The monitor 600 includes an input unit 610 for the user to input desired information to the computer 500. The input unit 610 is constituted by a keyboard, a mouse, a dial and a button, for example.

A concrete configuration of the apparatus 1000 will now be described in detail. The light irradiation unit 210 is disposed such that light is irradiated from the bottom of the acoustic wave detection unit 220 toward the object 1. In the light irradiation unit 210, light is guided from a light source (not illustrated) via an optical system. The light source is an apparatus that generates pulsed light. The light source is preferably a laser to acquire high power, but may be a light emitting diode or the like. To effectively generate the photoacoustic wave, the light must be irradiated in a sufficiently short time in accordance with the thermal characteristic of the object 1. If the object 1 is a living body, the pulse width of the pulsed light generated by the light source is preferably no more than several tens of nano seconds. The wavelength of the pulsed light is preferably 700 nm to 1200 nm of a near infrared region, which is called an “optical window”. The light in this region can reach a relatively deep area of a living body, hence information on a deep area of the living body can be acquired. If the purpose of measurement is only on the surface of the living body, about 500 to 700 nm (a range of visible light to the near infrared region) may be used. The optical system (not illustrated) is an apparatus to guide the pulsed light generated in the light source to the object 1. In concrete terms, optical devices, such as a lens, mirror, prism, optical fiber and diffusion plate, are used. When the light is guided, the shape and density of the light may be changed using these optical devices so that the light distribution becomes the desired one. The optical devices are not limited to those mentioned above, but may be any device that can implement this function.

The maximum permissible exposure (MPE) is specified by a safety standard, for the allowable light intensity to be irradiated to biological tissue. Examples of such a standard are: IEC 40825-1: Safety of laser products; JIS C6802: Safety standards for laser products; FDA: 21CFR Part 1040.10; and ANSI Z136.1: Laser safety standards. The maximum permissible exposure is a light intensity that can be irradiated to a unit area. Therefore more light can be guided to the object 1 if light is irradiated simultaneously over a wider area on the surface of the object 1. Then the photoacoustic wave can be received at a higher S/N ratio. As a consequence, it is preferable to spread the light over a certain sized area, rather than condensing the light by a lens.

The support 222 is integrated with a tray 221 that holds the matching solution for acoustically matching (acoustically coupling) the plurality of acoustic wave detection elements 223 and the cup 112. In the tray 221, the discharge joint 271, to connect with the later mentioned matching solution circulation unit 400, is disposed.

The scanning stage 230 is constituted by an X scanning stage 231, which scans the light irradiation unit 210 and the acoustic wave detection unit 220 in the X direction (shorter side direction of the bed 110), and the Y scanning stage 232, which scans the light irradiation unit 210 and the acoustic wave detection unit 220 in the Y direction (longer side direction of the bed 110). The X direction here is a direction of moving the subject, which is supported in a face down state, to the left or right. The Y direction is a direction of moving the subject toward the head or toes. In other words, scanning is performed with changing the positional relationship between the object 1 and the acoustic wave detection unit 220/light irradiation unit 210. The X and Y scanning stages are controlled by a motor, a linear guide and a balls crew (not illustrated) respectively, based on an instruction from the later mentioned operation unit 510 (corresponding to the position control unit). Because of this configuration, the acoustic wave detection unit 220 can be scanned two-dimensionally in the X and Y directions. The scanning stage 230 is not limited to the above mentioned mechanism, but may be a linked mechanism, a gear mechanism, a hydraulic mechanism or the like, as long as the mechanism can drive the acoustic wave detection unit 220 for scanning. Further, instead of linear driving using a linear guide, a rotational mechanism may be used for scanning. The X scanning stage 231 and the Y scanning stage 232 have an origin sensor and a linear encoder (not illustrated) respectively, so as to detect a position of the acoustic wave detection unit 220 with respect to the measurement unit 200. The movement of the scanning stage 230 is preferably continuous, but may be repeated at predetermined steps.

Now a surfactant to suppress the generation of bubbles, which are mixed into the matching solution, and a configuration of related members, will be described. In this example, about 36 L of matching solution is stored in the tank 401. The matching solution is distilled water, of which electric conductance is 5_{μ}S or less. A container 411 holding the surfactant is integrated to an upper part of the tank 401. In the container 411, a feeding mechanism 414 is disposed for the user to feed the surfactant to the tank 401 via the operation at the input unit 610 (the unit constituted by the container 411 and the feeding mechanism 414 corresponds to the addition unit). In this example, 6 mL of surfactant is added to 36 L of the matching solution. The characteristic of the surfactant greatly changes depending on the concentration, hence it is preferable to manage the concentration of the surfactant in the matching solution. For this purpose, a concentration meter 412 for detecting the concentration of the surfactant in the matching solution (corresponding to the concentration detection unit) is disposed in the tank 401. Various conventional techniques can be used for the concentration measuring method by the concentration meter 412. The concentration meter 412 may be disposed outside the tank 401, and in this case, a part of the matching solution in the tank 401 or in the acoustic wave detection unit 220 (outside the tank 401) is sampled, and a concentration of this sample (the concentration measurement target) is detected. A mixer 413 (corresponding to the stirring unit) is disposed in the tank 401 to evenly stir the surfactant in the tank into the matching solution. The mixer 413 may be driven only when the apparatus 1000 is ON, or may be driven only when the user operates at the input unit 610. It is preferable that the mixer 413 stirs the matching solution at a speed that does not generate bubbles. The concentration detection result by the concentration meter 412 may be displayed on the monitor 600, or a lamp may be disposed in a location that the user can visually recognize, so that the level of the concentration and appropriateness of the concentration are indicated by a lit state and a color of the lamp. Based on the information on the concentration detected by the concentration meter 412, the user increases the concentration by adding an amount of the surfactant, or decreases the concentration by replenishing the distilled water to the matching solution in the tank 401, so as to adjust the concentration to an appropriate level. A tank for storing the distilled water (not illustrated) may be separately disposed so that the distilled water is automatically replenished to the tank 401 according to the concentration detected by the concentration meter 412, in order to maintain the matching solution at a desired concentration.

Now a generation of bubbles in the state where the surfactant is not added, and in the state where the surfactant is added, and the suppression of bubbles, will be described.

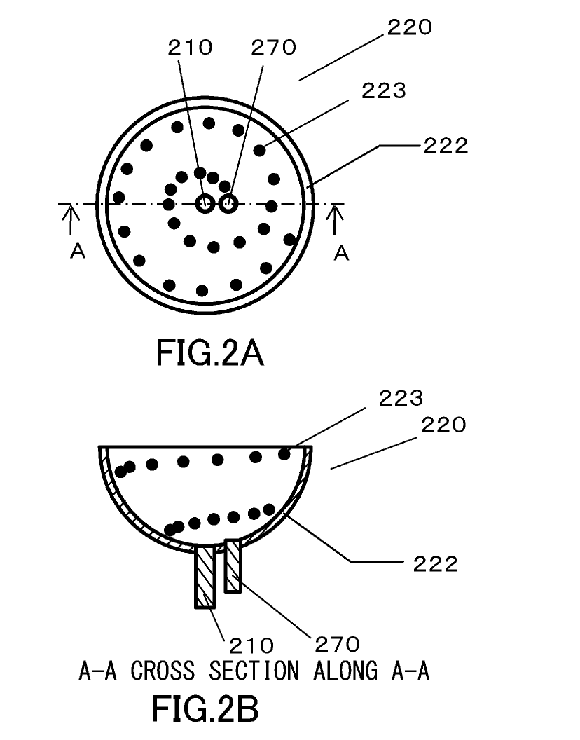

FIG. 2A and FIG. 2B are schematic diagrams of the acoustic wave detection unit according to Example 1. FIG. 2A is a plan view of the acoustic wave detection unit 220, and FIG. 2B is a cross-sectional view sectioned along the line A-A in FIG. 2A. The acoustic wave detection unit 220 is basically constituted by a hemispherical support 222, and a plurality of acoustic wave detection elements 223 which is disposed approximately hemispherically on the inner surface of the support 222. By disposing a plurality of acoustic wave detection elements 223 like this, the directional axes thereof converge to an area near the center of an approximately spherical curvature. The acoustic wave from the area where the directional axes are converged can be received at high sensitivity. Then for each positional relationship between the object 1 and the acoustic wave detection element 223, corresponding to the area where the acoustic wave can be received at high sensitivity, the plurality of acoustic wave detection elements 223 irradiates light and receives the acoustic wave which is generated in the object 1 and propagated. The positional relationship between the object 1 and the acoustic wave detection element 223 is naturally determined if the positional relationship between the object 1 and the acoustic wave detection unit 220 is determined. By reconstructing the image based on the receive signal acquired for each of the positional relationships, highly accurate images can be acquired. In this example, the directional axes of all the acoustic wave detection elements 223 converge to an area near the center of the curvature. But the present invention is not limited to this, and at least a part of the plurality of acoustic wave detection elements 223 may converge to an area near the center of the curvature.

In the bottom of the acoustic wave detection unit 220, the supply joint 270, to be connected with the later mentioned matching solution circulation unit 400, is disposed. The acoustic wave detection element 223 receives a photoacoustic wave and converts the reception result into an electric signal. For the members constituting the acoustic wave detection element 223, a piezoelectric ceramic material represented by lead zirconate titanate (PZT) or a polymer piezoelectric film represented by polyvinylidene fluoride (PVDF), for example, can be used. An element other than a piezoelectric element may be used. For example, a capacitance type element, such as capacitive micro-machined ultrasonic transducers (CMUT) may be used.

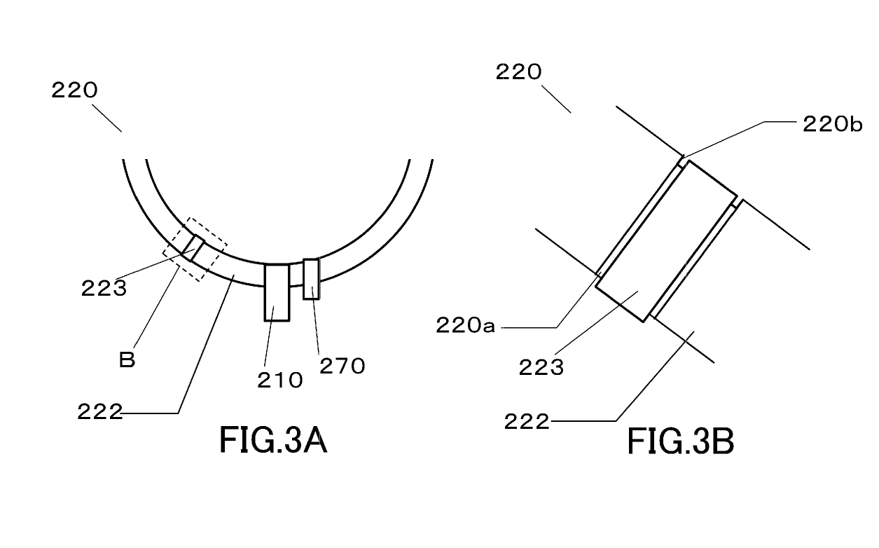

FIG. 3A and FIG. 3B are end views of the acoustic wave detection unit according to Example 1. FIG. 3A is an end view of the acoustic wave detection unit 220, and FIG. 3B is an enlarged view of the range B in FIG. 3A. A hole 220b, to insert the acoustic wave detection element 223, is disposed in the acoustic wave detection unit 220, and the acoustic wave detection element 223, inserted into the hole 220b, is glued by adhesive 220a. As a result, the inner surface of the acoustic wave detection unit 220 is not smooth, but has extensive unevenness that exists. The light irradiation unit 210 and the supply joint 270 also cause unevenness in the inner surface of the acoustic wave detection unit 220. Further, fine unevenness generated in the processing step of the acoustic wave detection unit 220 also exists on the inner surface of the acoustic wave detection unit 220.

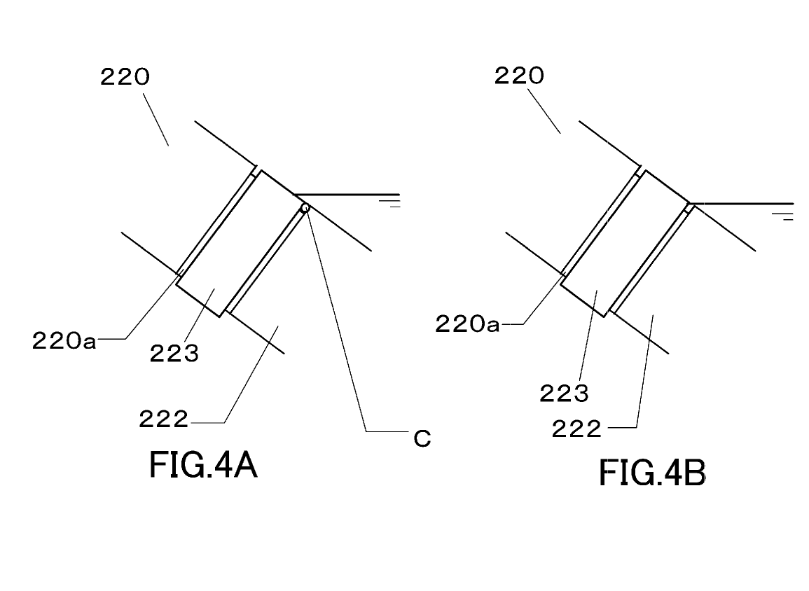

FIG. 4A and FIG. 4B are diagrams depicting a case of supplying the matching solution to the acoustic wave detection unit 220 in FIG. 3B. FIG. 4A is a diagram depicting a case of supplying a non-added surfactant matching solution to the acoustic wave detection unit 220. If the matching solution, to which the surfactant is not added, is poured onto the surface having the unevenness, the air C in the space of the depressed portions may remain due to surface tension. In this case, the remaining air C generates bubbles on the reception surface or the like of the acoustic wave detection unit 220. FIG. 4B is a diagram depicting a case of supplying an added surfactant matching solution to the acoustic wave detection unit 220. The surface tension decreases if the surfactant is added to the matching solution. Therefore the matching solution fills the narrow spaces in the depressed portions, and prevents air from remaining there. In other words, adding the surfactant to the matching solution can suppress the generation of bubbles when the matching solution is supplied. The generation of bubbles can be suppressed not only in the acoustic wave detection unit 220, but also in locations where the matching solutions flows, such as the tray 221 and the matching solution circulation unit 400, and in locations where the matching solution comes in contact, such as the cup 112.

### Other Examples

Embodiments of various characteristics of the present invention are not limited to the above mentioned example. For example, dimensions, materials, shapes or the like of the composing elements should be approximately changed depending on the configuration and various conditions of the apparatus to which the present invention is applied.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of U.S. Provisional Application No. 62/046,330, filed on Sep. 5, 2014, which is hereby incorporated by reference herein in its entirety.

What is claimed is:

1. An object information acquiring apparatus comprising:
a matching solution that is prepared by adding, to a solvent, a solute having a higher hydrophilicity than the solvent, and propagates an acoustic wave generated from an object;
a plurality of acoustic wave detection elements that receives the acoustic wave via the matching solution;
a support that supports the plurality of acoustic wave detection elements so that directional axes of at least a part of the acoustic wave detection elements converge, and holds the matching solution;
a position control unit that changes a positional relationship between the object and the support; and
an acquisition unit that acquires characteristic information on the object based on a reception result for each positional relationship of the plurality of acoustic wave detection elements.

2. The object information acquiring apparatus according to claim 1, further comprising a concentration detection unit that detects concentration of the solute.

3. The object information acquiring apparatus according to claim 2, further comprising a display unit that displays a detection result of the concentration detection unit.

4. The object information acquiring apparatus according to claim 3, further comprising an addition unit that adds the solute to the solvent.

5. The object information acquiring apparatus according to claim 4, further comprising a stirring unit for stirring the solute.

6. The object information acquiring apparatus according to claim 5, further comprising a tank that stores the matching solution, wherein
the tank, the concentration detection unit, the addition unit and the stirring unit are integrated.

7. The object information acquiring apparatus according to claim 1, wherein
the solute is a surfactant.

8. The object information acquiring apparatus according to claim 6, further comprising:
a supply path for supplying the matching solution stored in the tank to the support; and
a discharge path for discharging the matching solution supported by the support to the tank.

9. The object information acquiring apparatus according to claim 8, further comprising:
a flow meter that is disposed in the supply path, and detects a flow rate of the matching solution.

10. The object information acquiring apparatus according to claim 9, further comprising:
a pump that is disposed between the flow meter and the tank in the supply path, and supplies the matching solution from the tank to the support at a predetermined flow rate.

11. The object information acquiring apparatus according to claim 10, further comprising:
a negative feedback control unit that drives the pump so as to supply the matching solution from the tank to the support at a predetermined flow rate based on a detection result of the flow meter.

12. The object information acquiring apparatus according to claim 8, further comprising:
a supply joint that is disposed in the support and connects the supply path and the support; and
a discharge joint that is disposed in the support and connects the discharge path and the support.

13. An object information acquiring apparatus comprising:
a matching solution that is prepared by adding a solute having hydrophilicity to water, and propagates an acoustic wave generated from an object;
a plurality of acoustic wave detection elements that receives the acoustic wave via the matching solution;
a support that supports the plurality of acoustic wave detection elements so that directional axes of at least a part of the acoustic wave detection elements converge, and holds the matching solution;
a position control unit that changes a positional relationship between the object and the support; and
an acquisition unit that acquires characteristic information on the object based on a reception result for each positional relationship of the plurality of acoustic wave detection elements.

14. The object information acquiring apparatus according to claim 13, wherein
the solute is a surfactant.

15. The object information acquiring apparatus according to claim 1, further comprising:
a light irradiation unit that propagates the acoustic wave by irradiating light onto the object.

16. The object information acquiring apparatus according to claim 15, wherein
the light irradiation unit is integrated with the support.

17. The object information acquiring apparatus according to claim 1, wherein
the support supports the plurality of acoustic wave detection elements approximately hemispherically.
